(19) United States
(12) Patent Application Publication
(10) Pub. No.: US 2011/0290511 A1
(43) Pub. Date: Dec. 1, 2011

(54) Aerator attachment with self-retracting penetrating spikes

(76) Inventor: James B. Nahass, Amherst, NH (US)

(21) Appl. No.: 12/802,125

(22) Filed: Jun. 1, 2010

(51) Int. Cl. A01B 45/02

(52) U.S. Cl. 172/21

(57) ABSTRACT

A turf aerator device for attachment to regularly disposed vehicle wheels, including lawnmower wheels. The device comprises two armed attachment bracket, a sliding attachment bracket, a locking pin plate and a plurality of penetrating spikes. The device easily attaches to the lawnmower wheels by hand, without any modification to, removal of, or elevation of the wheels. The spike mechanisms penetrate the lawn surface by using the weight of the lawnmower and accompanying wheel rotation, as the lawn is being mowed. Without interruption or adjustments during use, the spikes will penetrate lawn surface and retract when wheels roll over hard surfaces, preventing any damage to driveways, walkways and other surrounding surfaces.

### FIELD OF THE INVENTION

The present invention relates generally to turf aeration and lawn care equipment and specifically to removably attachable turf aeration systems which may be affixed to, and rotate with, the wheels of an existing apparatus, namely a lawn mowing mechanism.

### BACKGROUND OF THE INVENTION

The present apparatus relates to a lawnmower attachment for aeration of the lawn surface while mowing the lawn. Aeration permits nutrients and water to penetrate the lawn surface and reach the root system. Aeration promotes lawn health, while helping to eliminate runoff. The object of the present invention is to provide an aerating device which can be easily attached to and removed from lawnmower wheels by hand, without any permanent modification to the wheels or lawnmower. Self retracting penetrating spikes allow the user to leave the device on the wheels and without adjustments, traverse hard surfaces without damaging the surface or the device itself. Prior devices in the art, for example, U.S. Pat. No. 5,662,172 issued to Brown, would require permanently attached parts or wheel modifications along with the tools and expertise to install them. Prior devices in the art would require removal or adjustments during use to allow the lawnmower to roll over hard surfaces such as driveways, garage floor, or walkways without doing damage to these surfaces or the device itself.

### SUMMARY OF THE INVENTION

In one embodiment, the present apparatus comprises a removable aerating device for lawnmowers to aerate the lawn surface while mowing the lawn. It easily attaches to wheels by hand, without the use of tools or permanent modification to the wheels or tires. Using the weight of the mower and rotation of the wheel, the spikes penetrate and aerate the lawn surface as the lawn is mowed. A compression spring on each penetrating spike of the present invention allows the spike to aerate the lawn surface and retract when contacting hard surfaces such as driveways. This enables the user to mow and aerate the lawn without interruption and without damaging hard surfaces.

Accordingly, an improved removably attachable aerating device for vehicles and accompanying enhancements and its component elements are herein described, which achieve these objectives, plus other advantages and enhancements. These improvements to the art will be apparent from the following description of the invention when considered in conjunction with the accompanying drawings wherein there has thus been outlined, rather broadly, the more important features of the removable attachable aerating device in order that the detailed description thereof that follows may be better understood, and in order that the present contribution to the art may be better appreciated.

There are additional features of the invention that will be described hereinafter and which will form the subject matter of the claims appended hereto. In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

These together with other objects of the invention, along with the various features of novelty, which characterize the invention, are pointed out with particularity in the claims annexed to and forming a part of this disclosure. For a better understanding of the invention, its operating advantages and the specific objects attained by its uses, reference should be made to the accompanying drawings and descriptive matter in which there are illustrated preferred embodiments of the invention. Other features and advantages of the present invention will become apparent from the following description of the preferred embodiment(s), taken in conjunction with the accompanying drawings, which illustrate, by way of example, the principles of the invention.

### BRIEF DESCRIPTION OF THE DRAWINGS

FIG. 1 is a perspective view of the aerating attachment according to the present device mounted on an existing wheel;

FIG. 2 is the fully assembled aeration device off the wheel;

FIG. 3. is an exploded perspective view of the two-armed bracket and lock pin plate;

FIG. 4 is a perspective view of the two-armed bracket with the lock pin plate attached and the unattached sliding bracket; and,

FIG. 5 is an exploded perspective of the sliding bracket and penetrating spike.

### DETAILED DESCRIPTION OF THE INVENTION

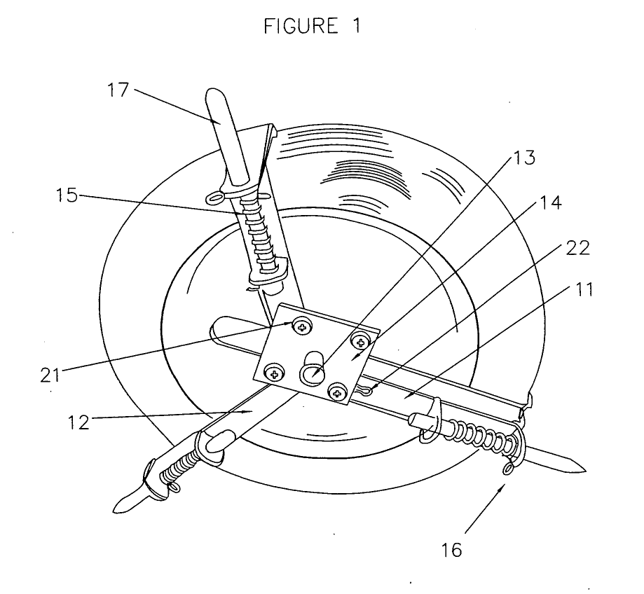

As seen in FIG. 1, in one embodiment of the present apparatus, the device is mounted to the outside of the wheel by positioning the two-armed bracket 12, with lock pin plate 14 attached, on the wheel and inserting sliding bracket 11. The brackets are placed on the wheel without any permanently attached parts or modifications to the wheel. The present invention can be installed on or removed from the wheel simply by setting or releasing the spring lock pin 13 from sliding bracket 11. Spike 17 extends beyond the wheel circumference to penetrate the turf surface as the wheel moves over the turf. It should be noted that all the parts of the preferred embodiment are made of steel, but other materials such as PVC could be used to produce all or some of the its parts.

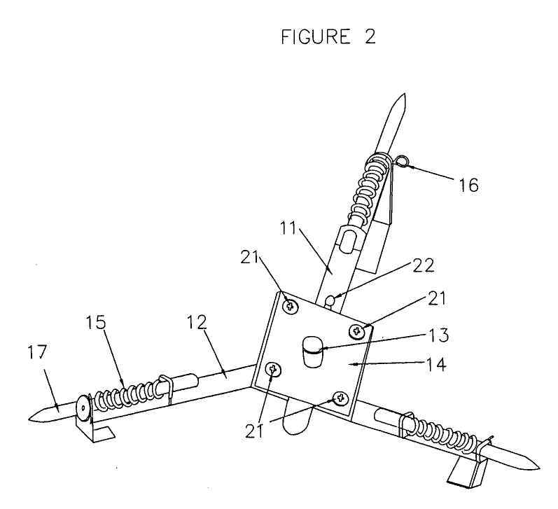

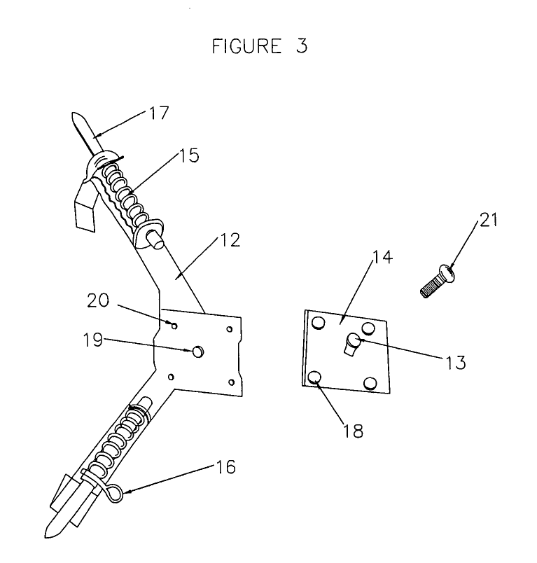

FIG. 2 shows the fully assembled embodiment of the aerating device off the wheel. FIG. 3 is an exploded view showing how the bend in the two-armed bracket 12 where the lock pin plate 14 attaches to it, creates a channel 24, through which the sliding bracket 11 can pass. The two-armed bracket 12 has four threaded thru holes 20 and one unthreaded thru hole 19. The lock pin plate 14 has a mounted spring lock pin 13 and four thru holes 18. The lock pin plate 14 is secured to the bracket 12 by pan head machine screws 21 passing through holes 18 and 20.

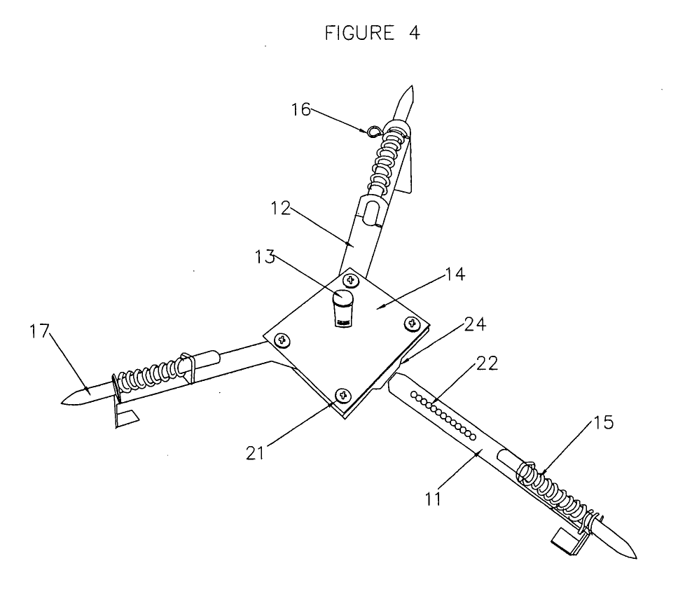

FIG. 4 is a perspective view of the two-armed bracket 12 and the lock pin plate 14 connected and the channel 24 created by the connection. Thus, pulling up on lock pin 13 opens channel 24 to allow sliding bracket 11 to pass through channel 24. When the brackets are tight against the wheel, the lock pin 13 can be released through one of a plurality of overlapping thru holes 22 and locked in place by passing through thru hole 19.

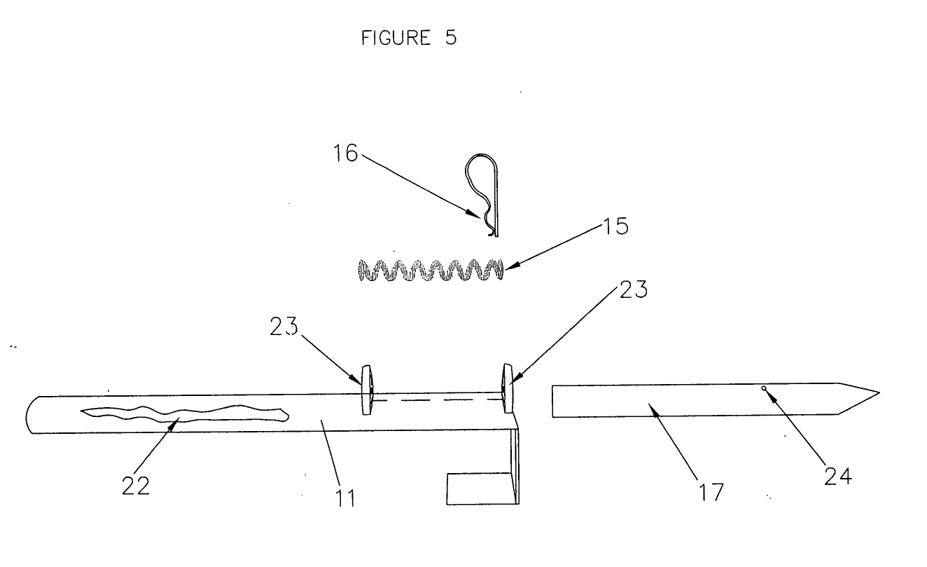

FIG. 5 shows an exploded view of the sliding bracket 11 and how the spike 17 attaches to it. Compression spring 15 is placed between thru holes 23 of the bracket 11. The spike 17, with through hole 24, passes through hole 23, through spring 15 and through second hole 23. It is secured onto the bracket with a hair pin cotter pin 16 passing through hole 24. It should be understood that all spikes of the present invention are assembled in the same manner.

In an additional embodiment, illustrated is a turf traction and aeration system, a centrally disposed retaining mechanism comprising at least one adjustable retaining mechanism; at least one static attachment mechanism comprising a proximal end and a distal end, wherein said proximal end of said at least one static attachment member is affixed to said centrally disposed retaining mechanism and wherein said distal end of said at least one static attachment member extends outwardly from said centrally disposed retaining mechanism; at least one removable slidably attachable dynamic attachment member comprising a proximal end and a distal end, wherein said proximal end of said at least one dynamic attachment member is in slidable communication with said centrally disposed retaining mechanism and wherein said distal end of said at least one dynamic attachment member extends outwardly from said centrally disposed retaining mechanism, and wherein at least one dynamic attachment member is in communication with said least one adjustable retaining mechanism of said centrally disposed retaining mechanism.

Additionally, the at least one first reciprocating member may comprise a substantially conical distal portion, said at least one first reciprocating member is in communication with said distal portion of at least one static attachment mechanism and may further comprise at least one second reciprocating member comprising a substantially conical distal portion, wherein said at least one second reciprocating member is in communication with said distal portion of said at least one dynamic attachment mechanism; and, wherein upon attachment of said turf traction and aeration system to an associated rotational mechanism, said at least one first reciprocating member and said at least one second reciprocating member extend and retract upon initiating physical contact with a respective malleable surfaces and unyielding surfaces.

Further, the turf traction and aeration system may be removably attachable and may comprises two static attachment mechanisms disposed at equidistant angles with respect to each other adjacent attachment mechanism so as to properly support the apparatus on a substantially circular mechanism. Additionally, the static attachment members may comprises a u-shaped fastening mechanism for initial fasting to a wheel mechanism.

Also, the dynamic attachment mechanism may comprise a slotted aperture in communication with said at least one adjustment mechanism of said centrally disposed retaining mechanism and wherein the adjustment mechanism of said centrally disposed retaining mechanism comprises an axially advancing lock screw. In addition, the first reciprocating member may comprise a spring loaded compression member and the second reciprocating member may comprise a spring loaded compression member. Furthermore, the reciprocating members may be affixed to the distal end of the static and dynamic attachment attachment mechanism by a locking pin mechanism.

Moreover, method for utilizing the turf traction and aeration system may comprise positioning said distal end of said at least one static attachment mechanism securely around a backside of said wheel; positioning the proximal end of said at least one removable slidably attachable dynamic attachment member within said centrally disposed retaining mechanism; extending said distal end of said at least one removable slidably attachable dynamic attachment member within securely around a backside of said wheel; and, finally locking said proximal end of said at least one removable slidably attachable dynamic attachment member in position with respect to said centrally disposed retaining mechanism with said least one adjustable retaining mechanism.

What is claimed is:

1. A turf traction and aeration system:
a centrally disposed retaining mechanism comprising at least one adjustable retaining mechanism;
at least one static attachment mechanism comprising a proximal end and a distal end, wherein said proximal end of said at least one static attachment member is affixed to said centrally disposed retaining mechanism and wherein said distal end of said at least one static attachment member extends outwardly from said centrally disposed retaining mechanism;
at least one removable slidably attachable dynamic attachment member comprising a proximal end and a distal end, wherein said proximal end of said at least one dynamic attachment member is in slidable communication with said centrally disposed retaining mechanism and wherein said distal end of said at least one dynamic attachment member extends outwardly from said centrally disposed retaining mechanism, and wherein at least one dynamic attachment member is in communication with said least one adjustable retaining mechanism of said centrally disposed retaining mechanism;
at least one first reciprocating member comprising a substantially conical distal portion, said at least one first reciprocating member in communication with said distal portion of at least one static attachment mechanism;
at least one second reciprocating member comprising a substantially conical distal portion, said at least one second reciprocating member in communication with said distal portion of said at least one dynamic attachment mechanism; and, wherein upon attachment of said turf traction and aeration system to an associated rotational mechanism, said at least one first reciprocating member and said at least one second reciprocating member extend and retract upon initiating physical contact with a respective malleable surfaces and unyielding surfaces.

2. The turf traction and aeration system of claim 1 wherein said turf traction and aeration system is removably attachable.

3. The turf traction and aeration system of claim 1 wherein said at least one static attachment mechanism comprises two static attachment mechanisms.

4. The turf traction and aeration system of claim 1 wherein said two static attachment mechanisms and said at least one dynamic attachment mechanism are disposed at equidistant angles with respect to each other adjacent attachment mechanism so as to properly support said apparatus on a substantially circular mechanism.

5. The turf traction and aeration system of claim 1 wherein said at least one static attachment member further comprises a u-shaped fastening mechanism for initial fasting to a wheel mechanism.

6. The turf traction and aeration system of claim 1 wherein said at least one dynamic attachment mechanism comprises a slotted aperture in communication with said at least one adjustment mechanism of said centrally disposed retaining mechanism.

7. The turf traction and aeration system of claim 1 wherein said adjustment mechanism of said centrally disposed retaining mechanism comprises an axially advancing lock screw.

8. The turf traction and aeration system of claim 1 wherein said at least one first reciprocating member comprises a spring loaded compression member.

9. The turf traction and aeration system of claim 1 wherein said at least one second reciprocating member comprises a spring loaded compression member.

10. The turf traction and aeration system of claim 1 wherein said at least one first reciprocating member comprising a substantially conical distal portion is affixed to said distal end of said at least one static attachment mechanism by a locking pin mechanism.

11. A method of attaching a turf aeration system comprising:
positioning said distal end of said at least one static attachment mechanism securely around a backside of said wheel;
positioning the proximal end of said at least one removable slidably attachable dynamic attachment member within said centrally disposed retaining mechanism;
extending said distal end of said at least one removable slidably attachable dynamic attachment member within securely around a backside of said wheel; and,
locking said proximal end of said at least one removable slidably attachable dynamic attachment member in position with respect to said centrally disposed retaining mechanism with said least one adjustable retaining mechanism.
